(19) United States
(12) Patent Application Publication
(10) Pub. No.: US 2005/0215313 A1
(43) Pub. Date: Sep. 29, 2005

(54) Communal gaming jackpot method

(75) Inventor: Terry O'Halloran, Bellevue Hill (AU)

Correspondence Address: SACCO & ASSOCIATES, PA, P.O. BOX 30999, PALM BEACH GARDENS, FL, 33420-0999, US

(73) Assignee: Stargames Corporation Pty Limited, Milperra (AU)

(21) Appl. No.: 11/071,427

(22) Filed: Mar. 3, 2005

(30) Foreign Application Priority Data
Mar. 3, 2004 (AU) 2004901060

(51) Int. Cl. A63F 13/00

(52) U.S. Cl. 463/26

(57) ABSTRACT

A jackpot method and system for use in a communal gaming arrangement. In the event that a jackpot is awarded, each player is allocated a probability of winning based upon their wagers in the relevant game, and then a random process selects the winner responsive to the probabilities. It allows a jackpot to be awarded when all players have bet on a common game outcome, and is applicable to random or symbol driven jackpots.

### CROSS REFERENCE TO RELATED APPLICATIONS

This application claims the priority of Australian patent application number 2004901060 filed on Mar. 3, 2004.

### TECHNICAL FIELD

This invention relates to the provision of pooled jackpots in a communal gaming system.

### BACKGROUND ART

On many gaming machine systems, random or mystery jackpots are implemented. Such a jackpot is awarded to a player at a time in play, and is not dependant upon the player achieving a particular combination of symbols or the like on the machine. Whilst such jackpots may be implemented on single machines, the common implementation of such a game uses a jackpot pooled across many machines, so that the jackpot is relatively large and is won at reasonable intervals.

Another type of pooled jackpot relies upon a player achieving a particular combination of symbols in the course of play.

The jackpot value in linked mystery jackpot games is incremented by a designated portion of each player's wager being added to the pool. Each contribution is added to the pool until the pool reaches some value, generally between limits known to the players. The exact value for payout is not known to the players, so providing the mystery or random aspect. In a typical implementation, when the jackpot increments to the payout value, the prize is awarded to the player whose contribution took the jackpot to the payout value. The payout value may be, for example, randomly selected after each win within the advertised range. More elaborate schemes may be used to determine prizes, but the winner is selected using this principle.

In a jackpot game reliant upon the player achieving a particular combination of symbols, the value similarly increments until one of the players has the correct combination, and the value accumulated to that time is paid as a jackpot. The jackpot may be payable for several combinations, or only part paid in some cases, but the principle remains the same.

In such a conventional jackpot game, a single player wins the jackpot as their machine makes the critical increment or displays the correct combination. However, this approach cannot be readily applied to communal gaming machines.

In a communal gaming environment, a central result is wagered on by players at multiple terminals. All players are reliant on the one result, regardless of their individual betting options. All bets on a round of gaming occur functionally at the same time. Hence, it is not possible to determine who should win the random jackpot prize on the ‘last increment’ basis. Similarly, on a symbol driven basis, all players (ignoring issues of separate paylines) have the same symbol outcome. The prize could be shared among all players, but this would reduce the incentive for players to increase their bet and give themselves a greater chance of winning the jackpot. It is an object of the present invention to provide a method of awarding a jackpot within a communal gaming system that is fair to players dependant on the size of their wager.

### SUMMARY OF THE INVENTION

In a broad form, the present invention uses a conventional approach to determine whether a jackpot should be awarded, for example by using the total contributions on each game to determine if the predetermined value is reached, or by awaiting a specific outcome of the game. Each player is then automatically allocated a probability of winning the jackpot, proportional to their wager in relation to the total bet by all players on the winning game. A conventional random number generator can then be used to determine the winner amongst the participating players.

According to one aspect, the present invention provides a method of awarding a jackpot in a communal gaming system, said method including at least the steps of:
(a) determining that a jackpot prize will be awarded;
(b) determining the wager made by each player on the current game, and allocating each player a probability of winning said jackpot proportional to the respective wager relative to a total of player wagers; and
(c) randomly determining the winner from amongst the players, responsive to each said probability.

According to another aspect, the present invention provides a jackpot system for communal games, including a jackpot controller, a game outcome generator and a plurality of gaming machines, the gaming machines each allowing players to make wagers on a common game outcome generated by the game outcome generator, wherein once the system determines that a jackpot prize will be awarded, the jackpot controller determines the wager made by each player on the current game, and allocates to each player a probability of winning said jackpot proportional to the respective wager relative to a total of player wagers, and randomly determines the winner from amongst the players, responsive to each said probability.

This method ensures that the chance of winning is proportional to the wagers made on the winning game, as is generally the case for jackpots in non-communal systems. However, it preserves the mystery aspect of the jackpot, wherein players do not know which game will result in the jackpot being awarded.

The present invention may be applied to both communal slot or moving reel type games, or to communal simulated or automated games such as roulette, sic-bo, or baccarat.

### BRIEF DESCRIPTION OF THE DRAWINGS

The present invention will be described with reference to the accompanying figures, in which:

FIG. 1 is a flowchart illustrating one implementation of the inventive method; and

FIG. 2 is a schematic illustration of a communal gaming system.

### DETAILED DESCRIPTION

The present invention will be described in the context of a particular implementation, suitable for example for a communal moving reels game. It will be appreciated that apart from varying payouts to accommodate the portion of each wager attributable to the jackpot, the ordinary operation of the game is not required to be modified. Hence, the present invention could be implemented as an additional feature on any communal game.

In the case of a moving reels type game, or in any case where players can select multiple paylines, some care in implementation will be required. If a player has not bet on the payline in which a jackpot combination occurs, for example, they would not participate in the opportunity to win the jackpot. It will be understood that each payline will have to consider wins based on both shared symbols, and symbols unique to that line alone. This arrangement may result in multiple coinciding wins for each payline, and this must be factored into the mathematical return of the game in question.

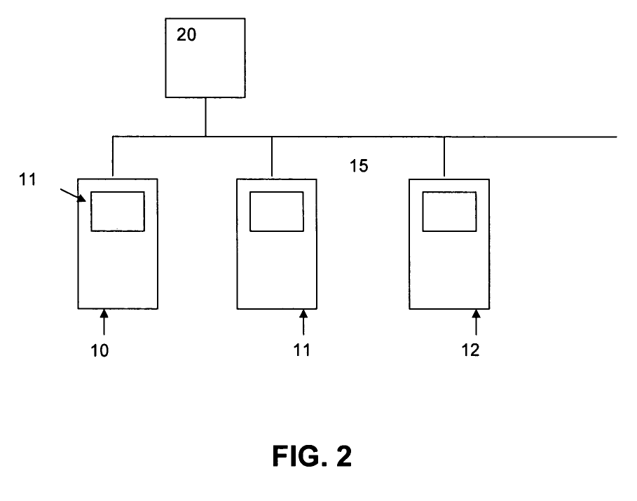

FIG. 2 shows one general arrangement of a communal gaming system. Central controller 20 is linked via network 15 to a plurality of individual gaming machines 10, 11, 12. Each gaming machine includes normal features of a gaming machine, such as a display 14, and other usual features (not shown) such as buttons to control wagers, selection of play features, and the like. The precise configuration of the machine is not essential to the present invention. The communal game system differs from conventional stand alone machines in that each machine is not actually operating the game as such. The local machine is only required to accept wagers and the like, and display bets and results to the player. The symbols for display, and game results, are generated by the central controller 20, which may be considered in this illustrative form as including a game outcome generator, for determining the outcome of games, communal displays, etc, and a jackpot controller for carrying out the jackpot functions. In some implementations, one of the gaming machines 10, 11, 12 may function as the game outcome generator, and communicate game outcomes to the other gaming machines. However, it is preferred that the jackpot functions are carried out by a separate jackpot controller, as it the case for conventional jackpot systems.

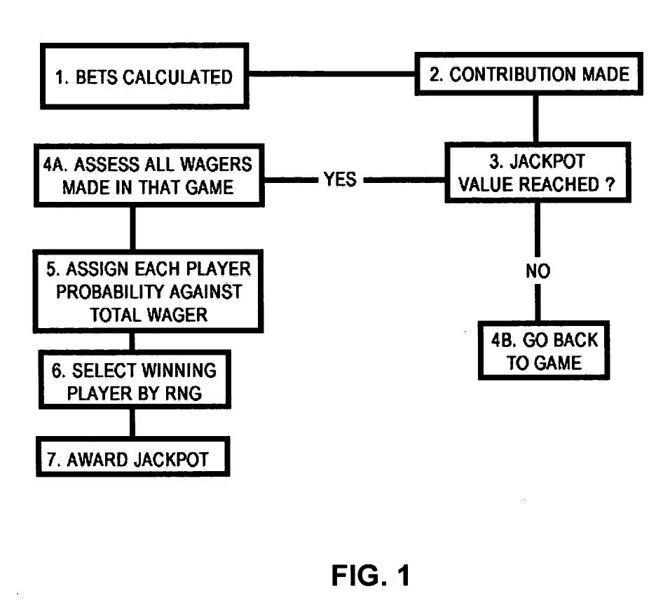

FIG. 1 shows a simple implementation of the present invention.
1. All bets are calculated by the (central) machine from all players active in that game
2. An allocated contribution as a percentage of the total bet is then contributed to the jackpot amount. In common with existing jackpot games, it is preferred that the current jackpot amount be displayed on the player's terminals, and/or in the gaming venue.
3. The updated value is then compared against the pre-determined value.
4. If there is a match (A) will apply where all wagers for that game are totalled to arrive at value Y, if (B) occurs, the game continues
5. Each player's bet A1, A2, A3 . . . An is assigned a probability based on their bet divided by the total bet by all players in that game (where An is the last player). In other words, the win probability for each player is directly proportional to the player's wager in the game in which the jackpot is awarded.
6. Once the probability has been assigned, a random number generator (rng) determines which player has won the jackpot.
7. The jackpot is awarded to the successful player.

Using a simple example, there are 5 players playing $1 each on a communal game, and the mystery jackpot parameters are set between $10 and $20. That means that the random jackpot must go off between those values. The escalating jackpot is updated after each game with a designated amount being added to the progressive value. In our example, we assume that the percentage is 10%, such that on every game, $0.50 (10% of $5) is being contributed. Assuming also the machine decided to award the jackpot once the total hit $11.00, the jackpot would be awarded after 2 games ($10+2×$0.50).

Upon the value being reached, all values from player terminals that participated in that game will be eligible to win the jackpot. Each player is then assigned a share equal to his or her bet over the total bet on the game that triggered the jackpot. The machine's random number generator will then issue a result based on the weighted averages and award the jackpot to a player who participated in that game. The jackpot will be awarded directly to the player who it is awarded to and the jackpot will reset to the lowest parameter value.

The inventive method may be employed with an alternative way of determining that a jackpot should be awarded, or the amount. For example, when the jackpot value is reached, a separate prize game could be commenced to determine how much of the jackpot has been won. Other variations to this part of the method as are used or known for conventional jackpot games can be employed.

It is preferred that each player's chance of winning the jackpot is proportional to the wagers made in the game which triggers the jackpot. However, the invention could be implemented using the average of wagers over a selected number of earlier games. This potentially raises issues of equity for players who have left the game earlier.

The present invention may be implemented at a single site, or across many sites linked by suitable communications and control systems, such as are well known for conventional linked jackpot systems.

It will be appreciated that the present invention is of broad application, and can be implemented in a variety of ways. Variations and additions are possible within the general scope of the present invention.

1. A method of awarding a jackpot in a communal gaming system, said method including at least the steps of:
(a) determining that a jackpot prize will be awarded;
(b) determining the wager made by each player on the current game, and allocating each player a probability of winning said jackpot proportional to the respective wager relative to a total of player wagers; and
(c) randomly determining the winner from amongst the players, responsive to each said probability.

2. A method according to claim 1, wherein step (a) includes determining, prior to accumulating a jackpot, a prize level at which the jackpot will be awarded, allocating a portion of each wager to a jackpot pool, and determining that a jackpot will be awarded when the jackpot pool reaches or exceeds the prize level.

3. A method according to claim 1, wherein step (b) is calculated using the portion of the wager allocated to the jackpot pool.

4. A method according to claim 1, wherein step (a) occurs when one or more predetermined play outcomes occur.

5. A method according to claim 4, wherein in a simulated reels game the predetermined play outcome is a predetermined symbol combination.

6. A method according to claim 1, wherein step (a) is determined by a random process.

7. A method according to claim 1, wherein step (c) uses a random number generator.

8. A jackpot system for communal games, including a jackpot controller; a game outcome generator and a plurality of gaming machines, the gaming machines each allowing players to make wagers on a common game outcome generated by the game outcome generator, wherein once the system determines that a jackpot prize will be awarded, the jackpot controller determines the wager made by each player on the current game, and allocates to each player a probability of winning said jackpot proportional to the respective wager relative to a total of player wagers, and randomly determines the winner from amongst the players, responsive to each said probability.

9. A jackpot system according to claim 8, wherein the system determines that a jackpot will be awarded when one or more predetermined play outcomes occur.

10. A jackpot system according to claim 9, wherein in a simulated reels game the predetermined outcome is a predetermined symbol combination.

11. A jackpot system according to claim 8, wherein step (a) includes determining, prior to accumulating a jackpot, a prize level at which the jackpot will be awarded, allocating a portion of each wager to a jackpot pool, and determining that a jackpot will be awarded when the jackpot pool reaches or exceeds the prize level.

12. A jackpot system according to claim 8, wherein the respective player wager used to allocate a probability is calculated using the portion of the wager allocated to the jackpot pool.

13. A jackpot controller operatively adapted to carry out the method of claim 1.

14. A software product operatively adapted to carry out the method of 1.
